(19) United States
(12) Patent Application Publication
(10) Pub. No.: US 2015/0007189 A1
(43) Pub. Date: Jan. 1, 2015

(54) SERVICE RATE REDISTRIBUTION FOR CREDIT-BASED ARBITRATION

(71) Applicants: Robert De Gruijl, San Francisco, CA (US); Michael T. Klinglesmith, Portland, OR (US)

(72) Inventors: Robert De Gruijl, San Francisco, CA (US); Michael T. Klinglesmith, Portland, OR (US)

(21) Appl. No.: 14/126,899

(22) PCT Filed: Jun. 29, 2013
(86) PCT No.: PCT/US2013/048805

§ 371 Date: Dec. 17, 2013

(51) Int. Cl. G06F 9/50

(52) U.S. Cl. CPC G06F 9/5011; G06F 9/5016
USPC 718/104

(57) ABSTRACT

A particular requester of three or more requesters of a shared system resource is determined to be inactive. Each of the three or more requesters is allocated a respective service rate that each represents a corresponding share of available bandwidth of the system resource and the respective service rate of the particular requester is a first service rate that represents a first share of the bandwidth. Portions of the first share of the bandwidth are reallocated to each active requester in the three or more requesters to distribute the first portion of the bandwidth according to the relative services rates of the active requesters while the particular requester remains inactive.

### FIELD

This disclosure pertains to computing system, and in particular (but not exclusively) to credit-based arbitration in computing systems.

### BACKGROUND

Computing systems can provide shared system resources that can be potentially accessed by multiple different components, channels, and processes. Such shared resources can include buses, memory, cache, and other resources. In some cases, access by the multiple “requesters” can be predictable based on a pre-set or determine behavior of the interacting requesters. In other cases, multiple requesters can compete for a shared resource and the access attempts (or requests) of the shared resource can be unpredictable, bursty, and over-assertive. Solutions have been developed for managing the sometimes “greedy” behavior of these competing components. For instance, credit-based flow control schemes have been developed, such as the credit-based schemes described in specification of the Peripheral Component Interconnect (PCI) Express (PCIe) architecture, which attempts to control congestion and competing requests on a link-by-link or virtual channel (VC)-by-VC basis. Some solutions have further utilized the Credit Controlled Static Priority (CCSP) algorithm in connection with flow control mechanisms deployed in systems with shared resource arbitration, among other examples.

### BRIEF DESCRIPTION OF THE DRAWINGS

FIG. 1 illustrates an embodiment of a block diagram for a computing system including a multicore processor.

FIG. 2 illustrates an embodiment of a interconnect architecture including a layered stack.

FIG. 3 illustrates a simplified block diagram of an example arbitrator.

FIG. 4 illustrates a simplified diagram representing an example arbitration of access to a shared resource.

FIG. 5 illustrates graphs representing credit-based arbitration of access to a shared resource.

FIG. 6 illustrates a graph representing an example reallocation of a share of bandwidth of an inactive requester to active requesters according to one particular embodiment.

FIG. 7 is a simplified flowchart of example techniques relating to the reallocation of service in response to an inactive requester of a shared system resource.

FIG. 8 illustrates an embodiment of a block for a computing system including multiple processor sockets.

FIG. 9 illustrates another embodiment of a block diagram for a computing system.

Like reference numbers and designations in the various drawings indicate like elements.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

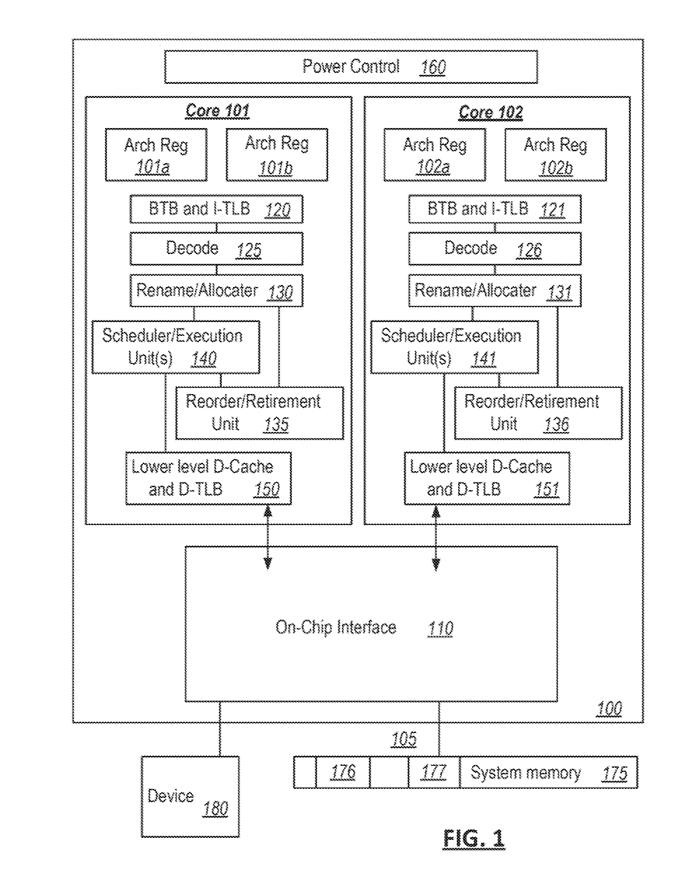

Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores-core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 11 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

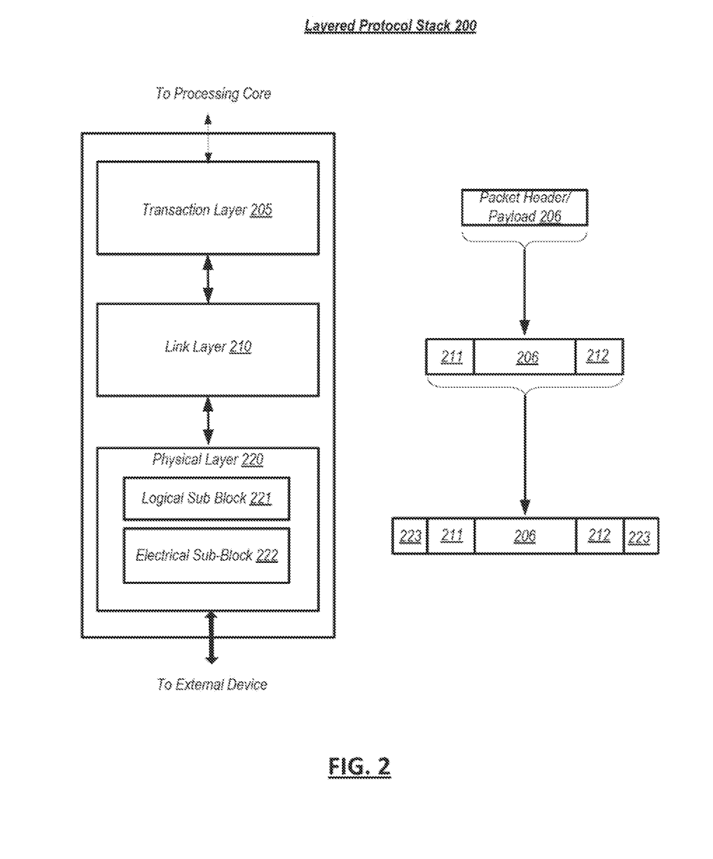

Example interconnect fabrics and protocols can include such examples a Peripheral Component Interconnect (PCI) Express (PCIe) architecture, Intel QuickPath Interconnect (QPI) architecture, Mobile Industry Processor Interface (MIPI), among others. A range of supported processors may be reached through use of multiple domains or other interconnects between node controllers. An interconnect fabric architecture can include a definition of a layered protocol architecture. In one embodiment, protocol layers (coherent, non-coherent, and optionally other memory based protocols), a routing layer, a link layer, and a physical layer can be provided. Furthermore, the interconnect can include enhancements related to power managers, design for test and debug (DFT), fault handling, registers, security, etc. For example, in one implementation illustrated in FIG. 2, a layered protocol stack 200 is illustrated including, for instance, a transaction layer 205, link layer 210, and physical layer 220. An interface of computing device may be represented as communication protocol stack 200. Representation as a communication protocol stack may also be referred to as a module or interface implementing/including a protocol stack.

Data can be organized as phits, flits, packets, etc. and be used to communicate information between components. Packets can be formed, for instance, in the Transaction Layer 205 and Data Link Layer 210 to carry the information from the transmitting component to the receiving component. As the transmitted packets flow through the other layers, they can be extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

In one embodiment, a protocol or transaction layer 205 can be used to provide an interface between a device's processing core and the interconnect architecture, such as data link layer 210 and physical layer 220. In this regard, a primary responsibility of the transaction layer 205 can include the assembly and disassembly of packets (i.e., transaction layer packets, or TLPs). In some implementations, the transaction layer 205 (or another layer) can manage credit-based flow control within a system, such as flow control for TLPs or other units of data. In some implementations, a credit-based flow control scheme can be utilized. In credit-based flow control, a device can advertise an initial amount of credit for each of the receive buffers in Transaction Layer 205. Whenever a packet or flit is sent to the receiver, the sender decrements its credit counters by one credit which represents either a packet, flit, message, etc. An external device at the opposite end of the link, such as a controller, can count the number of credits consumed by each TLP, message, request, transaction, etc. A transaction may be transmitted if the transaction does not exceed a credit limit. Additional credits can be issued and restore credits available to a device according to a priority or arbitration policy, in response to receiving a response to an earlier message or request, among other example. One example advantage of a credit scheme is that the latency of credit return does not affect performance, provided, for instance, that a credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the compatible devices. Transactions to the configuration space can include read requests and write requests. Message space transactions (or, simply messages) are defined to support in-band communication between agents on the interconnect fabric. Further, access to memory space can be allocated, for instance, through guaranteed service rates to memory bandwidth, among other examples.

Therefore, in one embodiment, transaction layer 205 assembles packet header/payload 206. Link layer 210, also referred to as data link layer 210, can act as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to another device, such as an external device.

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In some embodiments, a defined transmission code can be employed, such as an 8b/10b transmission code is employed, where ten-bit symbols are transmitted/received. In such instances, special symbols can be used to frame a packet with frames 223. In addition, in one example, the receiver also provides a symbol clock recovered from the incoming serial stream.

As stated above, although transaction layer 205, link layer 210, and physical layer 220 are discussed in reference to the example of FIG. 2, a layered protocol stack is not so limited. In fact, any layered protocol may be included/implemented. As an example, an port/interface that is represented as a layered protocol can includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized. In another implementation, a layered protocol can include protocol layers (coherent, non-coherent, and optionally other memory based protocols), a routing layer, a link layer, and a physical layer.

Physical layer 220, in one embodiment, is responsible for the fast transfer of information on the physical medium (electrical or optical etc.). The physical link is point to point between two Link layer entities. The Link layer 210 can abstract the Physical layer 220 from the upper layers and provides the capability to reliably transfer data (as well as requests) and manage flow control between two directly connected entities. It also is responsible for virtualizing the physical channel into multiple virtual channels and message classes. The Transaction layer 205 (or a protocol layer, in some embodiments) can rely on the Link layer 210 to map protocol messages into the appropriate message classes and virtual channels before handing them to the Physical layer 220 for transfer across the physical links. Link layer 210 may support multiple messages, such as a request, snoop, response, writeback, non-coherent data, etc.

In one embodiment, multiple agents may be connected to an interconnect architecture including, for instance, a home agent (orders requests to memory), caching (issues requests to coherent memory and responds to snoops), configuration (deals with configuration transactions), interrupt (processes interrupts), legacy (deals with legacy transactions), non-coherent (deals with non-coherent transactions), and others.

Contemporary system-on-chips (SoC) can include a large number of components and devices, including multiple processors, capable of being used to perform multiple tasks. Memory elements and the interconnect fabric can be shared by components of the system, although such sharing can result in competition between the components for these scarce system resources. In some use cases demanding real-time resource access, such as software video decoding, real-time requirements of the application can be difficult to satisfy, among other conflicts. Requests on system resources can be made by “requesters” including processes in the context of CPUs, or communication channels in case of a memory or an interconnect. Such requesters (and their request) can be made on behalf of an application or task. The combinations of tasks and applications active on a system and competing for its resources at any given time can vary. Further, requesters' demands for resources can fluctuate and the latency requirements for components and various applications can also vary.

Resource access can be managed by arbitrator logic and accompanying hardware. Resource access, such as shared access of memory resources, can demand high speed performance allowing access to be scheduled on a fine level of granularity, reducing latency and buffers. In some solutions, a guaranteed minimum service rate and a bounded maximum latency can be analytically verified at design time and attempted to be enforced using the arbitrator. An arbitrator can regulate access to the resources to guarantee requesters (e.g., a given process or channel) levels of access to the resources. An arbitrator can further attempt to isolate requesters from each other and protect against some requesters over-utilizing the shared resources and threatening other requesters from being able to access the portion of the available resources (or “bandwidth”) allocated to them.

Credit-based arbitration algorithms can be used in digital circuits or software systems to accurately and fairly guarantee a service-rate for multiple requesters (or “users”) of a shared resource, such as memory or interconnect bandwidth. One such algorithm is Credit Controlled Static Priority (CCSP). When applied to SoC interconnect fabrics, CCSP can, for instance, accurately guarantee service rates to multiple components and devices (such as on-chip and external components) using a single shared memory. Solutions such as CCSP can be well suited for systems with a well-defined use case, where all agents that require a guaranteed service rate are actively participating, or in systems where the CCSP service-rates can be re-programmed if the use-case changes (e.g. when a given component (such as an audio processor) is switched off and no longer requires service).

In a personal computer, mobile computer, and server-based platforms, re-programming service-rates is often not feasible, because system load changes constantly given the diversity of functions performed by the system. Further, many components may consistently (or always) attempt to access a greater portion of the shared resource than they are assigned, over-subscribing to the resource. As a result, in some instances, if a component in a SoC or another chip or system, such as a Serial ATA (SATA) port, stops utilizing service, or bandwidth, because no hard disk traffic is demanded, it can leave behind excess bandwidth, which can then be fairly re-distributed among those other more active components and requesters that could use the bandwidth. Existing arbitration algorithms can handle re-distribution of intermittent excess bandwidth poorly, for instance, because the algorithms determine eligibility based on provided service. Accordingly, if all components, or requesters, in the system ask for more of the resources than they were originally assigned, all corresponding agents will eventually operate beyond their programmed service rate. This can lead to un-fair distribution of excess bandwidth, among other issues.

An improved arbitration scheme can be provided capable of re-distributing the portion of allocated or bandwidth (or service rates) for one or more requester that become inactive and stop asking for service. Service rates of requesters can be dynamically adjusted for continuously changing use-cases. With such re-distribution of service rate, excess service can be distributed according to the relative service rates as programmed for each active requester, resulting in a continually fair distribution of service in a dynamically changing over-subscribed system. Such arbitration schemes can be provided, for instance, according to and utilizing principles of the example systems, algorithms, logic, techniques, and flows described herein.

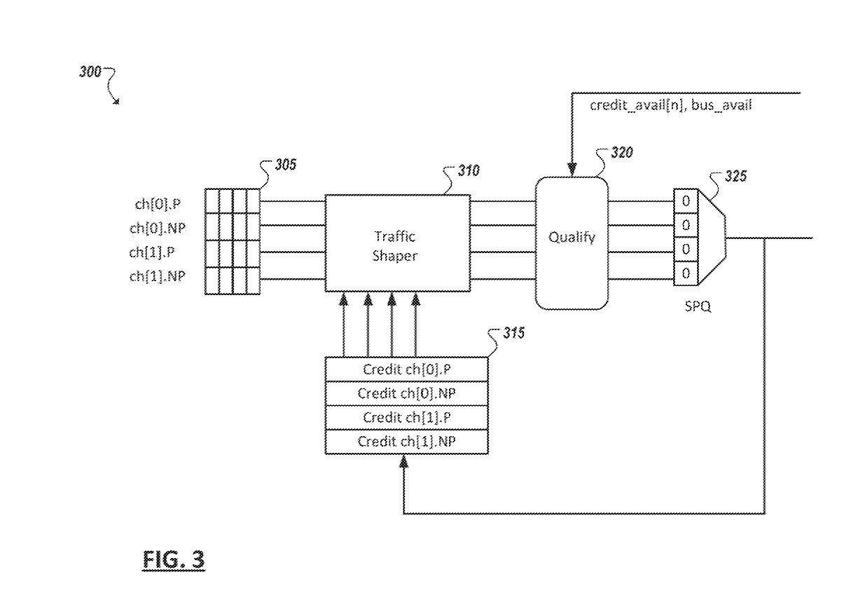

Turning to the example of FIG. 3, a simplified block diagram 300 is shown of an example arbitrator included in a computing system, such as on a SoC. A variety of components can be included so as to realize the functionality of an arbiter. For instance, in the particular example of FIG. 3, four requesters, such as channels Ch[0].P (for a posted flow of a first component), Ch[0].NP (for another, non-posted flow of the first component), Ch[1].P (for a posted flow of a second component), Ch[1].NP (for another, non-posted flow of the second component) can be provided. Requests (e.g., embodied as packets) can received at a queue 305 and a traffic shaper 310 can shape bursty traffic received on the queue 305 such that only a single request is granted in a given cycle. The traffic shaper 310 can shape traffic according to the respective service rates (or portion of the available memory bandwidth) allocated to each requester. Credit-based arbitration can be utilized and credit counters 315 for each of the requesters can keep track of actual accumulated service provided to each port (e.g., through the available credits for each requester), and update the credit counts for each requester at each cycle to accommodate for the use of credits during the cycle and the assignment of new credits, etc. When it is a requester's turn to enter a request (e.g., as determined by traffic shaper 310) qualify logic 320 can assess whether resources are available for the request. This can include determining whether the availability of the bus for accessing the resources as well as determining whether available storage space is available at the target of the transaction request. A static priority queue (SPQ) 325 can further function (e.g., along with traffic shaper 310) to assist in ensuring a fixed maximum latency for each requester or port, regardless of the requesters' respective service allocations. The SPQ 325 can guard against higher priority requesters starving lower priority requester (potentially making the latency unbounded). While the example of FIG. 3 illustrates certain components of an example arbitrator, it should be appreciated that other implementations can be realized capable of enabling the features described herein. Additionally, functionality of some of the components described in connection with the example of FIG. 3 can be combined or further divided into other components, arrangements, and systems.

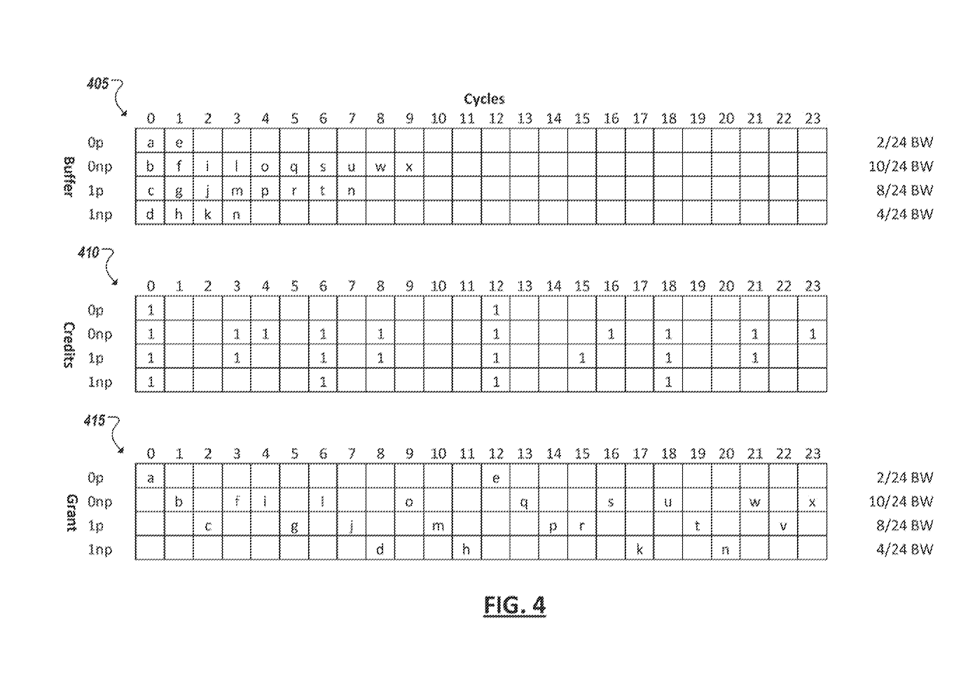

FIG. 4 is a block diagram illustrating an example flow of requests 405 by a plurality of requesters (e.g., “0p”, “0np”, “1p”, “1np”), allocation of credits 410 to the requesters, and the granting of the request (allowing the requester to access the requested shared resource) 412 over a series of 24 cycles (e.g., such as defined for a frequency or granularity at which access and transactions of the resource can be distributed). In the particular illustrative example of FIG. 4, four channels 0p, 0np, 1p, 1np (e.g., the channels of the example of FIG. 3) can be allocated a service rate for service of (or a portion of the available bandwidth of) the shared resource. For instance, a posted channel of a component “0” can be allocated 2/24 of the available bandwidth, such that the channel can be guaranteed a request twice every twenty-four cycles. Similarly, the other channels can be allocated their own respective guaranteed service rates, with channel “0np” being afforded the most generous access to the resource.

A variety of schemes and policies can be applied to determine an initial allocation of bandwidth, or service rate. The service rate can be affected, for instance, by what types of components are involved in the requests, the size of the buffers of the respective requesters (e.g., with smaller buffer size encouraging service rates that guarantee a safe maximum latency for the buffer), the type of application or task being performed in connection with the requester (e.g., hard vs. soft real-time activities, the resource-intensiveness of the activity, etc.), as well as the priority afforded a particular requester. The service rates assigned to requesters can change depending on the use case, the number and type of competing requesters, and other factors. Additionally, as use cases change, different use cases are supported, new components are enabled or added, etc. service rates can vary even when the same requesters are competing for the same resource. In some cases, service rates can be dynamically adjusted, for instance, by monitoring use cases of the components for changes in the use case for which a particular, current service rate was determined and assigned. As an illustrative example, a video processing component, at a first instance, can be processing high definition (HD) video and be allocated a first portion of the bandwidth at the first instance. If a user switches to a standard definition (SD) setting, the same video processing component can begin, at a later instant, processing SD video. This transition in the activities and use case of the particular component (e.g., the video processing component) can trigger the service rate for the particular component to be dynamically adjusted to account for the change in use case. Further, service rates of other components sharing the bandwidth of a resource with the particular component can have their respective service rates adjusted (e.g., proportionately) based on the dynamic adjustment of the service rate of the particular component (e.g., whose use case has changed), among other examples.

In the example of FIG. 4, bursty traffic is observed (at 405) on at least some of channels 0p, 0np, 1p, 1np. Further, in this example, competing requests arrive substantially concurrently, posing potentially the most difficulty for shaping the competing traffic and minimizing latency across the collection of requesters. For example, channel 0p attempts a request “a” immediately followed by a request “e”, channel 0np attempts ten requests (“b”, “f”, “i”, “l”, “o”, “q”, “s”, “u”, “w”, “x”) in succession (attempting to use all of its allocated bandwidth), and so on. Credits (at 410) for use in arbitrating which of the competing requests (e.g., requests “a”-“x”) is serially granted access to the shared resource. The credits can be granted, as shown at 410) in accordance with the service rate guaranteed the requester (channel). For instance, channel 0np can be guaranteed 10 credits per 24 cycles commensurate with its 10/24th bandwidth service rate, and the credits can be distributed (e.g., at cycles 0, 3, 4, 6, 8, 12, 16, 18, 21, and 23) over the 24 cycle period. Distribution of credits can be based on a variety of additional policies and determined using a variety of algorithms to attempt to assign a sufficient share of bandwidth to each of the plurality of competing requesters.

As shown at 415, only one request is capable of being granted at any one cycle. Qualification logic, a static priority queue, and components and logic can drive how and in what order such requests are granted. In the example of FIG. 4, each channel is to have at least one available credit (e.g., in total or over a threshold) in order to be permitted to access to a resource (i.e., have its request granted). For instance, as shown in this example, at cycle 0, each of the channels 0p, 0np, 1p, 1np has been granted at least one credit and, thus, has a credit available prior to the granting (e.g., at 415) of requests at cycle 0 and beyond. A priority policy enforced at the arbitrator can further be used to determine which of the competing requesters has priority in this instance. Priority can be fixed or dynamic, changing for instance, based on the particular use cases or actions underlying the respective requester, based on the number of requesters, the availability of excess bandwidth, among other examples. In this particular illustration, channel 0p has priority over the other three channels and is granted access to the shared resource first at cycle 0, followed by requester channels 0np at cycle 1 and channel 1p at cycle 2. Priority rules can cause other channels with priority to access a resource multiple times (in accordance with the availability of respective credits) prior to other requesters receiving any service. For example, in the example of FIG. 4, channel 1np waits until cycle 8 before its first request is granted despite having sufficient credits for its request (having been afforded two unused credits (see, e.g., 410 at cycle 0 and cycle 6) by cycle 8). In some implementations, latency maximums can be enforced to ensure that some lower-priority requesters are not queued so long that their latency exceeds the guaranteed maximum, among other examples. As shown in the example of FIG. 4, as credits are available, and as priority policies, maximum latency protections, oversubscription protections, and underutilization protections are enforced, the queued requests (at 405) can be gradually distributed across a period of cycles (as shown at 415) such that the guaranteed service rate is realized.

At some samples of time, in the example of FIG. 4, a given requester may be over- or under-utilizing their allocated portion of the bandwidth. For instance, between cycles 1 and 6, channel 0np enjoys 4/6 BW of the available service, far in excess of the 10/24 BW guaranteed to the channel. However, between cycles 7 and 12, the same channel is granted only 1/6 BW. Likewise, the other channels can be consuming more, less, or exactly that portion of the bandwidth allotted to them. Guaranteeing a service rate can be ensuring that the service rate is substantially accommodated over a particular period, such as a number of cycles. However, service guaranteed to a requester need not necessarily be used by the requester, in that the requester can be inactive and forfeit use of at least a portion of the guaranteed service, among other examples.

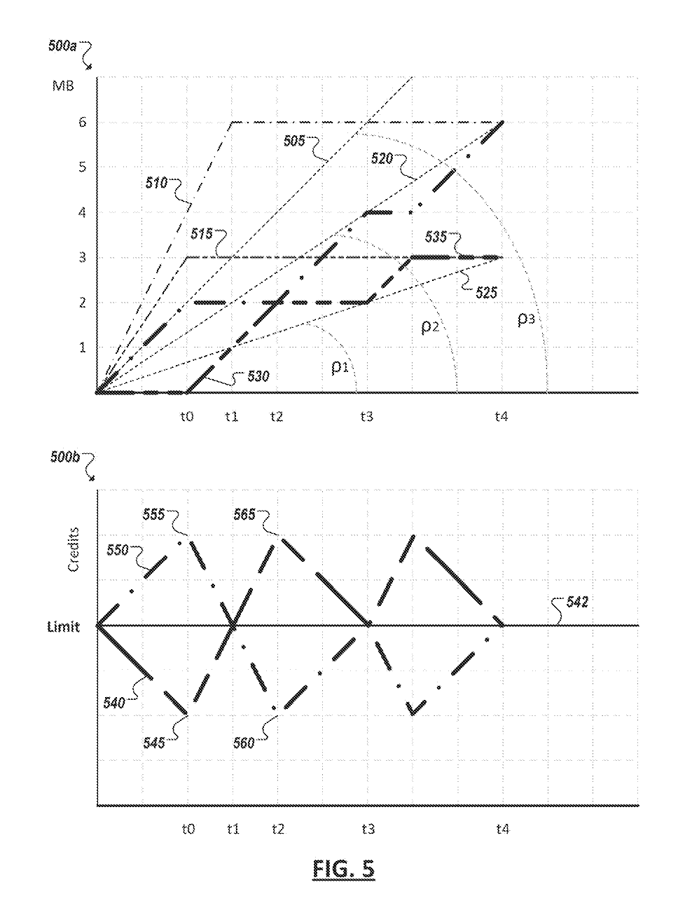

FIG. 5 illustrates another representation of bandwidth sharing between multiple requesters. In the example of FIG. 5, total memory bandwidth 505 is available and is to be allotted between two channels. In graph 500a, curve 510 represents the attempted requests of a first channel, while curve 515 represents the competing attempted requests of the second channel. However, as both of the attempted utilizations 510, 515 of the shared resource are in excess of the total bandwidth 505 available to the requester collectively, a credit-based arbitration scheme can be employed to coordinate access to the shared resource according to a guaranteed service rate to be allocated to the two respective channels. In this example, the first channel is allocated a first service rate 520 and the second channel is allocated a second, lower service rate 525. For example, the first channel can be allocated 2/3 BW while the second channel is only allocated 1/3 BW, as in the example of FIG. 5.

According to the priority policy applied to the arbitration of the two requesters, as represented by curve 530, the first channel begins by consuming all of the available bandwidth 505 up until time t0. During this period, as represented in graph 500b, the first channel steadily consumes credits allocated to it (as represented by curve 540), its credits dropping below a limit 542 until a threshold credit deficit is hit (e.g., at 545) or a threshold credit potential (as illustrated by point 555 of curve 550) of the second channel is hit. As represented in FIG. 5, as the first channel utilizes all the credits that it has and the second channel is left without service for a period, the credits that could be used (according to its guaranteed service rate) are stockpiled, resulting in credit potential. Likewise, as the second channel is granted service (e.g., at t0), the amount of service enjoyed by the first channel can be scaled back or quieted altogether, resulting in the excess credits of the second channel dropping (e.g., to 560) as credits 540 of the first channel replenish (e.g., beyond limit 542 to potential 565 as consumption of the resource by the first channel is halted from t0 to t2). Indeed, from t1 to t3, the second channel may be granted and consume service in excess of the guaranteed rate 525, while at other times enjoying less service (e.g., up to t1). However, each of the first and second channels, after a particular period (e.g., t4) may both have consumed the requisite amount of service in accordance with their respective service rates.

As noted above, a service rate can be assigned to each requester to guarantee a certain amount of service. The service rate can be specified as a numerator (Num) over a denominator (Denom) and represent a ratio of the overall available bandwidth allocated to the respective requester:

$${serviceRate}_{i} = \frac{{Num}_{i}}{Denom}$$

The guaranteed service (GS) can then be expressed simply as:

GS=serviceRate*Throughput (MB/s)

For each request, a credit count, or “service potential”, can be maintained and calculated according to a formula:

$$Potential = \{ \begin{matrix}grant = i : Clip ( {Potential}_{i} - ( {Denom}_{i} - {Num}_{i} ) ) \\ grant \neq i : Clip ( {Potential}_{i} + {Num}_{i} ) \\ grant = 0 : {Potential}_{i}\end{matrix} ,$$

where:

$$Clip ( x ) = \{ \begin{matrix}x \geq CLIP\_HIGH: CLIP\_HIGH \\ x \leq CLIP\_LOW: CLIP\_LOW \\ x\end{matrix}$$

As a requester is granted service, the credits (potential) reduces. If another requester is granted (and service to the first requester is momentarily suspended), potential increases. If, no service is provided, however, potential remains constant. Potential can be continuously updated for each cycle of service, both in command and data phases. Further, a requester can be determined eligible for service if:

Potentialᵢ>LIMIT

While an arbitrator can include logic for resolving competing requests for a shared resource, additional logic can also be provided to address instances where one of the requesters becomes temporarily inactive and does not utilize that portion of the bandwidth allocated to it. In some implementations, the portion of the bandwidth unused during an inactive period of a requester can be temporarily distributed to the active requesters to temporarily increase the service rates of the active requesters and make more efficient use of the available bandwidth of a shared resource. If no service-rate reprogramming is provided, as requesters become inactive, the highest priority requester agent may claim the entirety of the excess service left by the inactive requester. In such instances, the “rich get richer” and the service rate of lower priority active requesters remain the same—these requesters do not benefit from the excess service. In some schemes, when excess bandwidth is identified in connection with inactivity of one or more of the requesters, the excess bandwidth can be provided evenly to the remaining active requesters. For instance, priority can be adjusted during periods of inactivity by one or more requesters to cause each active requester to receive an equal portion of the inactive requester's service. However, such a scheme enriches those requesters with relatively lower service rates, as they are afforded the same quantitative increase in redistributed bandwidth as requesters with higher allocated service rates.

In an attempt to provide an illustrative example of the foregoing, nine (9) requesters (and accompanying components and agents) can be provided, such as six SATA channels and three PCIe channels competing for a single 4 MB/s resource and initially allocated the following service rates:
SATA[0].P.DMI=0.5/11 BW=0.18 MB/s
SATA[1].P.DMI=0.5/11 BW=0.18 MB/s
SATA[2].P.DMI==0.5/11 BW==0.18 MB/s
SATA[3].P.DMI==0.5/11 BW==0.18 MB/s
SATA[4].P.DMI=0.5/11 BW=0.18 MB/s
SATA[5].P.DMI=0.5/11 BW=0.18 MB/s
PCIe1.P.DMI=4/11 BW=1.45 MB/s
PCIe2a.P.DMI=2/11 BW=0.72 MB/s
PCIe2b.P.DMI=2/11 BW=0.72 MB/s.

In one hypothetical, all of the SATA requesters may drop out, leaving 3/11 BW (or 1.08 MB/s) of excess service. In a system that allows a higher or highest priority service to absorb the excess service, the resulting redistribution (during the SATA requesters' inactivity) could be realized as:
PCIe1.P.DMI=7/11 BW=2.55 MB/s
PCIe2a.P.DMI=2/11 BW=0.72 MB/s
PCIe2b.P.DMI=2/11 BW=0.72 MB/s.

In an example where excess service resulting from the inactivity of the SATA requesters is distributed in equal quantities (e.g., 1/11 BW) to the three remaining PCIe requesters, the resulting redistribution could be realized as:
PCIe1.P.DMI=5/11 BW=1.82 MB/s (25.4% increase over original rate)
PCIe2a.P.DMI=3/11 BW=1.09 MB/s (51.5% increase)
PCIe2b.P.DMI=3/11 BW=1.09 MB/s. (51.5% increase).

An improved service reprogramming and redistribution algorithm can be provided that re-allocates excess bandwidth based on and proportionate to the respective service rates of the requesters prior to the inactivity creating the excess bandwidth. For instance, re-allocating excess bandwidth based on and proportionate to the respective service rates of the requesters in the previous example can result in service rates:
PCIe1.P.DMI=5.5/11 BW=2.0 MB/s (38% increase)
PCIe2a.P.DMI=2.75/11 BW=1.0 MB/s (38% increase)
PCIe2b.P.DMI=2.75/11 BW=1.0 MB/s. (38% increase).

In one example, service rate re-distribution that retains the relative service-rates as assigned to the requesting components can be obtained such as in the preceding example by redistributing excess bandwidth of one or more idle requesters by redistributing the numerators of all non-active requesters to the common denominator (of the original allocation of service) according to a formula:

$${ServiceRate}_{i} = \frac{{Num}_{i}}{{Denom}_{active} - \sum {Num}_{inactive}}$$

Returning to the preceding example, with a common service rate denominator of 11 shared between the nine competing channels, as the numerator corresponding to the allocation to the six inactive channels (6*0.05=3) is subtracted from the denominator (11−3=8), the resulting service rates can be calculated as:
PCIe1.P.DMI=4/8 BW=5.5/11 BW=2.0 MB/s (38% increase)
PCIe2a.P.DMI=2/8 BW=2.75/11 BW=1.0 MB/s (38% increase)
PCIe2b.P.DMI=2/8 BW=2.75/11 BW===1.0 MB/s. (38% increase),
   where the resulting service rate distribution is again exactly relative to the service ratio between the remaining active requesters.

Redistribution of another requester's bandwidth can be triggered when the requester is determined to be inactive. Inactivity can be determined according to a variety of techniques. In one example, a threshold amount of potential, or credit count, for a requester can be set (or “potential saturation” for the requester) and inactivity of the requester can be identified based on the requester's credit count hitting the threshold. In some cases, this threshold can act as a ceiling, additionally causing the assignment of additional credits to the requester to be halted. In some instances, a threshold period of time can be set to identify inactivity of a requester. For instance, in one example, inactivity and redistribution of the corresponding requester's credits can be triggered when the credit count has hit a potential saturation and remained at (or, in some cases, above) this level for a particular predefined period of time. Other factors can also be utilized to determine when to trigger redistribution of a requester's bandwidth. Further, potential saturation levels, timeout values, and other thresholds can be defined specific to the individual requesters and be tailored not only to characteristics of the underlying component (e.g., buffer size, performance characteristics or history, etc.) but also based on the particular use-case. For instance, a component may be expected to have intermittent delays in requests during some applications but more consistent requests during other tasks. Accordingly, thresholds defined for a particular component, agent, or, more generally, requester can be based on a variety of factors and can be dynamically adjusted as the factors vary, such as in the case of changing use cases, the number of competing requesters, the presence of higher- or lower-priority requesters, etc.

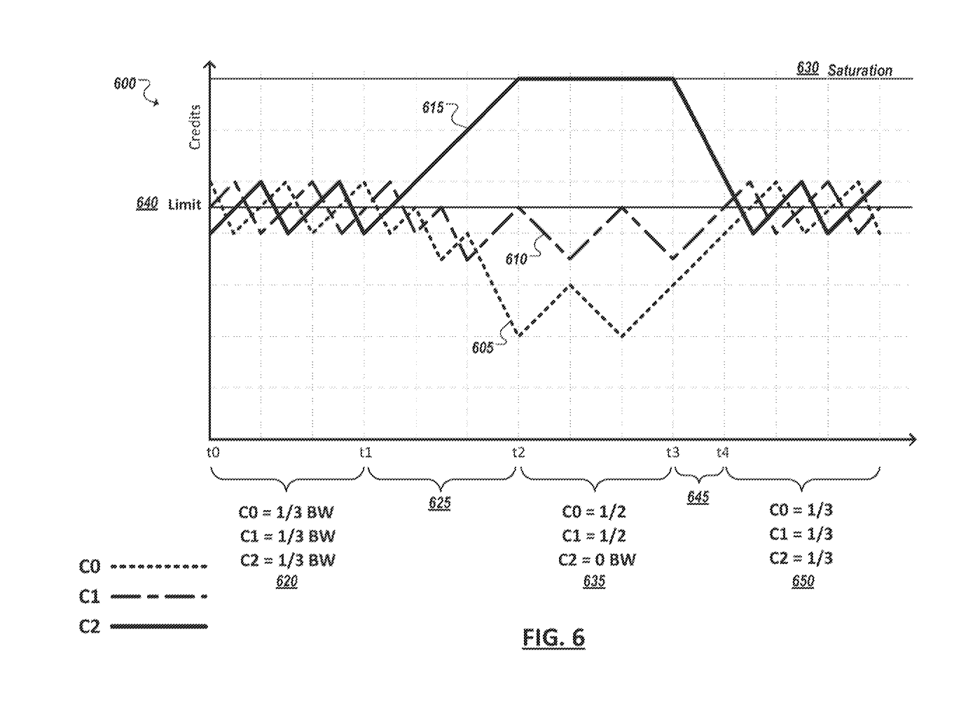

Turning to the example of FIG. 6, a graph 600 is shown illustrating three competing requesters, channels “C0”, “C1”, and “C2”. For ease of illustration, the example of FIG. 6 is a simplified example, where each of the channels have been allocated the same initial service rate. In real world implementations, any variety of different service rates can be programmed to be allocated to the requesters at a particular time. Indeed, more complex and numerous combinations of competing requesters can be expected with various different service rates in real world examples. Returning to the example of FIG. 6, at to channels can “C0”, “C1”, and “C2” can alternate between consuming service and waiting for credits to again resume service, as represented by curves 605, 610, 615 respectively. As the three requesters consume effectively all of the bandwidth allotted to them from time t0 to t1, each channel can share the same amount of service, as shown in the span from t0 to t1. However, at time t1, channel C2 begins to slow down or stop sending requests. Accordingly, requests of channel C2 are not granted and credits are not used. However, credits can continue to be assigned to the channel to assist in guaranteeing the service rate (e.g., at 620) allocated to the channel. As a consequence, as shown in FIG. 6, the credits of channel C2 rise from t1 to t2 (at 625). They can rise, in one example, until reaching a potential (or credit) saturation level 630. Further, an arbitrator can include logic to ensure that unused bandwidth or service (e.g., by channel C2) is not wasted. The logic can dictate that or otherwise allow for all or most of the excess bandwidth to be made available on the basis of priority (e.g., to the remaining active channel with the highest priority). In the example of FIG. 6, channel C0 is the highest priority channel and effectively fills the vacuum left by channel C2, consuming most of the excess bandwidth temporarily forfeited by channel C2 during 625, as shown in FIG. 6.

As noted above, potential saturation or other measures of inactivity by a requester can trigger the dynamic re-allocation or distribution of the inactive requester's bandwidth. For instance, at time t2, because the credit level of channel C2 hit the saturation level 630, channel C2 is determined to be at least temporarily inactive and the portion of the overall bandwidth assigned to channel C2 is distributed to the remaining active channels C0 and C1, while channel C2 remains inactive. In this particular example, bandwidth of channel C2 is re-allocated according to the equation:

$${ServiceRate}_{i} = \frac{{Num}_{i}}{{Denom}_{active} - \sum {Num}_{inactive}} .$$

Accordingly, the denominator of the ratio representing the service rate of the two active requesters is decreased by 1 (i.e., the numerator of the service rate of channel C2), adjusting the respective service rates of channels C0 and C1 to 1/2 BW and temporarily dropping the allocated service rate of the inactive channel C2 to 0, as shown at 635. With the service rate re-allocated between channels C0 and C1, no excess bandwidth remains (e.g., for C0 to disproportionately take). Instead, between t2 and t4, channels C0 and C1 enjoy balanced consumption of the memory bandwidth. Of note is that due to the reallocation, both C0 and C1 are permitted to have credit balances below limit 640, effectively readjusting the limit due to the inactivity of C2.

Continuing with this example, requester C2 may be reactivated, reawakened, or otherwise resume requests of the shared resource. Additional triggers can be defined for determining that the requester has resumed and that the original allocation of bandwidth should be resumed. In some instances, the sending of a request for the shared service can trigger the exit from the re-allocated service rate state (e.g., at 635), and return the service rates to their condition (e.g., at 620) preceding the inactivity by the channel C2. From time t3 to t4 (at 645), by identifying the reactivation of channel C2 and the large (e.g., saturated) credit count of the channel, channel C2 can be granted (e.g., using an arbitrator) sole access to the shared resource, allowing the channel C2 to effectively “catch-up” to the other channels C0 and C1. During this period, requests by the channels C0 and C1 can be buffered until the channels reach an equilibrium, such that the potentials of C0 and C1 are positive again (e.g., at t4) and can resume sharing of the resource as originally allocated (e.g., at 620). Accordingly, channels C0, C1, and C2 can each be restored to a service rate of 1/3 BW (e.g., at 650) until a change in the number of active channels, use cases of the channels, or other event is detected prompting re-programming or temporary reallocation of the shared resource's bandwidth.

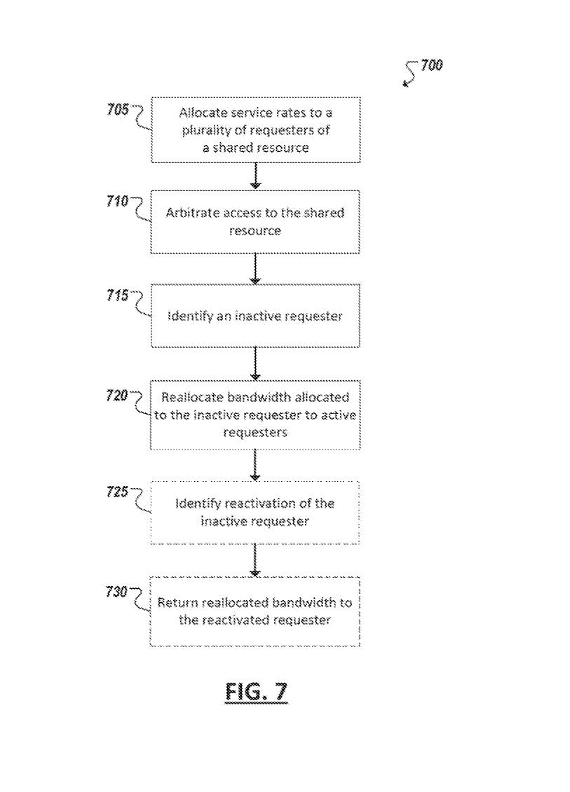

Turning now to the simplified flowchart 700 of FIG. 7, example techniques are illustrated relating to the reallocation of service in response to an inactive requester of a shared system resource. In one example, service rates can be allocated 705 to each of a plurality of requesters, such as agents of on-chip or other system components, attempting to gain access to a shared system resource. The service rates can be expressed as a ratio of the overall bandwidth of the system resource. The ratio can consist of a numerator and denominator. The competing attempts to access the system resource can be arbitrated 710, for instance, using an arbitrator component of the system. Arbitration can take place according to a credit-based scheme to guarantee the allocated service rates and enforce the relative priority of each requester to the shared resource. Additionally, functionality can be provided for re-programming service rates in response to one or more of the requesters becoming inactive for a period of time. In one example, an inactive requester can be identified 715, for instance, based on an inactivity threshold. The inactivity threshold can correspond to a potential saturation of credits assigned to the requester, a period of time in which the requester was inactive, among other examples. Identifying 715 the inactivity can trigger reallocation 720 of the portion of the bandwidth allocated to the inactive requester. The allocated bandwidth can be re-distributed to those requesters that are still active such that the bandwidth is re-allocated proportional to the relative service rates of the active requesters. The bandwidth can remain re-allocated until one or more of the inactive requester again becomes active. Reactivation of a previously inactive requester can be identified 725 and the portion of the re-allocated bandwidth originally allocated to the reactivated requester can be returned 730 to the reactivated requester, causing the service rates of each of the active requesters to again be re-adjusted to accommodate the reactivation of the requester. Any combination of the requesters can potential become inactive triggering reallocation (e.g., 720) of the requester's apportioned bandwidth to the remaining active requesters such that the relative service-rates are retained as originally assigned to the requesters. Accordingly, the service rate of each active requester can fluctuate as other requesters alternate between activity and inactivity, with each active requesters' requests being granted access to the shared resource according to the service rate presently allocated to them.

Note that the apparatus', methods', and systems described above may be implemented in any electronic device or system as aforementioned. As specific illustrations, the examples below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

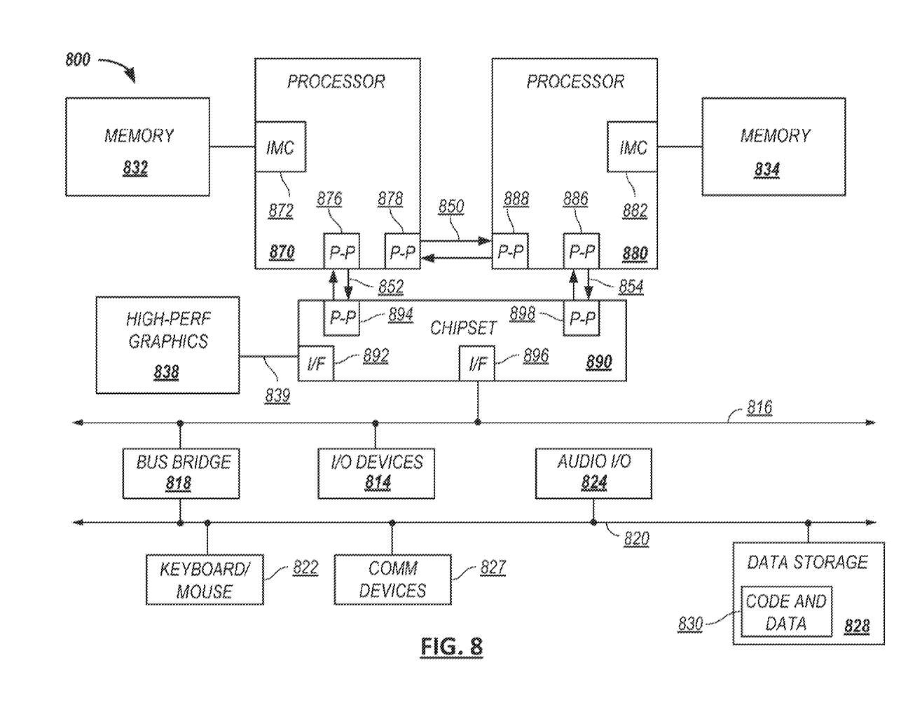

Referring now to FIG. 8, shown is a block diagram of a second system 800 in accordance with an embodiment of the present invention. As shown in FIG. 8, multiprocessor system 800 is a point-to-point interconnect system, and includes a first processor 870 and a second processor 880 coupled via a point-to-point interconnect 850. Each of processors 870 and 880 may be some version of a processor. In one embodiment, 852 and 854 are part of a serial, point-to-point coherent interconnect fabric, such as Intel's Quick Path Interconnect (QPI) architecture. As a result, the invention may be implemented within the QPI architecture.

While shown with only two processors 870, 880, it is to be understood that the scope of the present invention is not so limited. In other embodiments, one or more additional processors may be present in a given processor.

Processors 870 and 880 are shown including integrated memory controller units 872 and 882, respectively. Processor 870 also includes as part of its bus controller units point-to-point (P-P) interfaces 876 and 878; similarly, second processor 880 includes P-P interfaces 886 and 888. Processors 870, 880 may exchange information via a point-to-point (P-P) interface 850 using P-P interface circuits 878, 888. As shown in FIG. 8, IMCs 872 and 882 couple the processors to respective memories, namely a memory 832 and a memory 834, which may be portions of main memory locally attached to the respective processors.

Processors 870, 880 each exchange information with a chipset 890 via individual P-P interfaces 852, 854 using point to point interface circuits 876, 894, 886, 898. Chipset 890 also exchanges information with a high-performance graphics circuit 838 via an interface circuit 892 along a high-performance graphics interconnect 839.

A shared cache (not shown) may be included in either processor or outside of both processors; yet connected with the processors via P-P interconnect, such that either or both processors' local cache information may be stored in the shared cache if a processor is placed into a low power mode.

Chipset 890 may be coupled to a first bus 816 via an interface 896. In one embodiment, first bus 816 may be a Peripheral Component Interconnect (PCI) bus, or a bus such as a PCI Express bus or another third generation I/O interconnect bus, although the scope of the present invention is not so limited.

As shown in FIG. 8, various I/O devices 814 are coupled to first bus 816, along with a bus bridge 818 which couples first bus 816 to a second bus 820. In one embodiment, second bus 820 includes a low pin count (LPC) bus. Various devices are coupled to second bus 820 including, for example, a keyboard and/or mouse 822, communication devices 827 and a storage unit 828 such as a disk drive or other mass storage device which often includes instructions/code and data 830, in one embodiment. Further, an audio I/O 824 is shown coupled to second bus 820. Note that other architectures are possible, where the included components and interconnect architectures vary. For example, instead of the point-to-point architecture of FIG. 8, a system may implement a multi-drop bus or other such architecture.

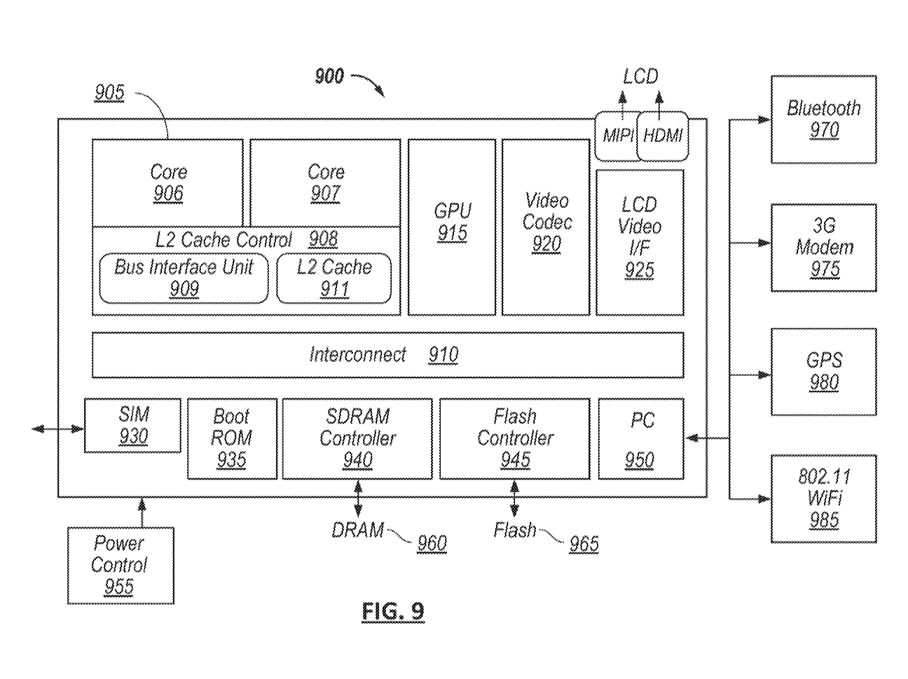

Turning next to FIG. 9, an embodiment of a system on-chip (SOC) design in accordance with the inventions is depicted. As a specific illustrative example, SOC 900 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 900 includes 2 cores—906 and 907. Similar to the discussion above, cores 906 and 907 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 906 and 907 are coupled to cache control 908 that is associated with bus interface unit 909 and L2 cache 910 to communicate with other parts of system 900. Interconnect 910 includes an on-chip interconnect, such as an IOSF, AMBA, or other interconnect discussed above, which potentially implements one or more aspects of the described invention.

Interface 910 provides communication channels to the other components, such as a Subscriber Identity Module (SIM) 930 to interface with a SIM card, a boot rom 935 to hold boot code for execution by cores 906 and 907 to initialize and boot SOC 900, a SDRAM controller 940 to interface with external memory (e.g. DRAM 960), a flash controller 945 to interface with non-volatile memory (e.g. Flash 965), a peripheral control 950 (e.g. Serial Peripheral Interface) to interface with peripherals, video codecs 920 and Video interface 925 to display and receive input (e.g. touch enabled input), GPU 915 to perform graphics related computations, etc. Any of these interfaces may incorporate aspects of the invention described herein.

In addition, the system illustrates peripherals for communication, such as a Bluetooth module 970, 3G modem 975, GPS 985, and WiFi 985. Note as stated above, a UE includes a radio for communication. As a result, these peripheral communication modules are not all required. However, in a UE some form a radio for external communication is to be included.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the microcontroller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. One or more embodiments may provide an apparatus, a system, a machine readable storage, a machine readable medium, and a method to determine that a particular requester of three or more requesters of a shared system resource is inactive, where each of the three or more requesters is to be allocated a respective service rate that is to represent a corresponding share of available bandwidth of the system resource and the respective service rate of the particular requester to be allocated comprises a first service rate that is to represent a first share of the bandwidth, and reallocate the first share of the bandwidth to each active requester in the three or more requesters to distribute the first portion of the bandwidth according to the relative services rates of the active requesters, where the first share of the bandwidth is to be reallocated while the particular requester remains inactive.

In at least one example, each of the services rates of the other requesters are increased according to the reallocation while the particular requester remains inactive.

In at least one example, a request is identified by the particular requester following reallocation of the first share of the bandwidth, and the first share of the bandwidth is returned to the particular requester based on the request.

In at least one example, determining that the particular requester is inactive. The determination can be based on a determination that the particular requester has met a pre-defined inactivity threshold. The inactivity threshold can include a threshold number of unused credits assigned to the particular requester according to the credit-based arbitration. The inactivity threshold can include a time-based threshold such as one based on an amount of time at or above the threshold number of unused credits. The inactivity threshold includes a requester-specific threshold and at least two of the three or more requester have different inactivity thresholds.

In at least one example, credit-based arbitration of requests is performed by the three or more requesters to the shared system resource.

In at least one example, the other requesters consume unused bandwidth allocated to the particular requester prior to the determined inactivity, and the consumption of the unused bandwidth prior to the determined activity is disproportionate to the relative services rates of the other requesters.

In at least one example, access to the shared system resource is based at least in part on relative priority of a requester to the other requesters in the three of more requesters.

In at least one example, each share of the bandwidth allocated to a respective one of the three or more requesters is expressed as a respective numerator over a common denominator and shares of the bandwidth of inactive requesters are to be redistributed to remaining active requesters according to a formula:

ServiceRate=Num_{—}i/(Denom−SUM(Num_inactive)),

where ServiceRaie is a service rate of a remaining active requester following the redistribution, Num_i is the numerator of the corresponding share of the bandwidth of the active requester, Denom is the denominator, and SUM(Num_inactive) is the sum of the respective numerators of the inactive requesters in the three or more requesters.

In at least one example, the three or more requesters comprise at least four requesters and at least one other requester is inactive when determining that the particular requester is inactive and reallocating the first share of the bandwidth to the active requesters.

In at least one example, access to the shared system resource by the three or more requesters is arbitrated.

In at least one example, arbitration is to guarantee the allocated service rate for each of the three or more requesters.

In at least one example, the arbitration is based at least in part on the respective service rates allocated to the three or more requesters and further based in part on relative priority of each of the three or more requesters to the shared system resource.

In at least one example, the service rate of at least one of the three or more requester is based at least in part on a particular activity performed by the requester in connection with access to the shared system resource by the requester.

In at least one example, the allocation logic is further to allocate the respective shares of the bandwidth to the three or more requesters.

One or more embodiments may provide a system including a shared system resource, a first device, and an arbitrator. The arbitrator can determine that a particular one of three or more requesters of the shared system resource is inactive. Each of the three or more requesters can be allocated a respective service rate representing a corresponding share of available bandwidth of the system resource and the allocated service rate of the particular requester can include a first service rate representing a first share of the bandwidth, and at least one of the three or more requesters can correspond to the first device. The arbitrator can reallocate the first share of the bandwidth to each active requester in the three or more requesters to distribute the first portion of the bandwidth according to the relative services rates of the active requesters, where the first share of the bandwidth is to be reallocated while the particular requester remains inactive.

In at least one example, the shared system resource includes at least a portion of an interconnect of the system.

In at least one example, the shared system resource includes a shared memory resource.

In at least one example, an apparatus is provided including an integrated circuit including a plurality of components, allocation logic to allocate a particular service rate to a particular component of the plurality of components based on a priority credit algorithm, and reallocation logic to reallocate the particular service rate to one or more of the plurality of components other than the particular component based on relative service rates of the one or more components in response to the particular component not continuing to request service.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1-26. (canceled)

27. An apparatus comprising:
logic to:
determine that a particular one of three or more requesters of a shared system resource is inactive, wherein each of the three or more requesters is allocated a respective service rate representing a corresponding share of available bandwidth of the system resource and the allocated service rate of the particular requester comprises a first service rate representing a first share of the bandwidth; and
reallocate the first share of the bandwidth to each active requester in the three or more requesters to distribute the first portion of the bandwidth according to the relative services rates of the active requesters, wherein the first share of the bandwidth is to be reallocated while the particular requester remains inactive.

28. The apparatus of claim 27, wherein each of the services rates of the other requesters are increased according to the reallocation while the particular requester remains inactive.

29. The apparatus of claim 27, wherein the logic is further to:
identify a request by the particular requester following reallocation of the first share of the bandwidth; and
return the first share of the bandwidth to the particular requester based on the request.

30. The apparatus of claim 27, wherein the determining that the particular requester is inactive is based on a determination that the particular requester has met a pre-defined inactivity threshold.

31. The apparatus of claim 30, wherein the logic is further to perform credit-based arbitration of requests by the three or more requesters to the shared system resource.

32. The apparatus of claim 31, wherein the inactivity threshold comprises a threshold number of unused credits assigned to the particular requester according to the credit-based arbitration.

33. The apparatus of claim 32, wherein the inactivity threshold comprises a time-based threshold based on an amount of time at or above the threshold number of unused credits.

34. The apparatus of claim 30, wherein the inactivity threshold comprises a time-based threshold.

35. The apparatus of claim 30, wherein the inactivity threshold comprises a requester-specific threshold and at least two of the three or more requester have different inactivity thresholds.

36. The apparatus of claim 27, wherein the other requesters consume unused bandwidth allocated to the particular requester prior to the determined inactivity, and the consumption of the unused bandwidth prior to the determined activity is disproportionate to the relative services rates of the other requesters.

37. The apparatus of claim 27, wherein access to the shared system resource is based at least in part on relative priority of a requester to the other requesters in the three of more requesters.

38. The apparatus of claim 27, wherein each share of the bandwidth allocated to a respective one of the three or more requesters is expressed as a respective numerator over a common denominator and shares of the bandwidth of inactive requesters are to be redistributed to remaining active requesters according to a formula:
ServiceRate=Num_{—}i/(Denom−SUM(Num_inactive)),
where ServiceRate is a service rate of a remaining active requester following the redistribution, Num_i is the numerator of the corresponding share of the bandwidth of the active requester, Denom is the denominator, and SUM(Num_inactive) is the sum of the respective numerators of the inactive requesters in the three or more requesters.

39. The apparatus of claim 27, wherein the three or more requesters comprise at least four requesters and at least one other requester is inactive when determining that the particular requester is inactive and reallocating the first share of the bandwidth to the active requesters.

40. The apparatus of claim 27, wherein the logic is further arbitrate access to the shared system resource by the three or more requesters.

41. The apparatus of claim 40, wherein arbitration is to guarantee the allocated service rate for each of the three or more requesters.

42. The apparatus of claim 40, wherein the arbitration is based at least in part on the respective service rates allocated to the three or more requesters and further based in part on relative priority of each of the three or more requesters to the shared system resource.

43. The apparatus of claim 27, wherein the service rate of at least one of the three or more requester is based at least in part on a particular activity performed by the requester in connection with access to the shared system resource by the requester.

44. The apparatus of claim 27, wherein the logic is further to allocate the respective shares of the bandwidth to the three or more requesters.

45. A method comprising:
arbitrating access to a particular shared system resource by three or more requesters, wherein each of the three or more requesters is allocated a respective service rate representing a corresponding share of available bandwidth of the system resource;
determining that a particular one of the requesters of a shared system resource is inactive in making requests of the system resource; and
reallocating the share of the available bandwidth corresponding to the respective service rate allocated to the particular requester to the active requesters in the three or more requesters the according to the relative services rates of the active requesters.

46. The method of claim 45, wherein each share of the bandwidth of the three or more requesters is expressed as a respective numerator over a common denominator, reallocating the share of the available bandwidth includes, for each of the active requesters:
identifying the numerator of the share of the bandwidth of the active requester;
summing the respective numerators of inactive requesters in the three or more requesters; and
determining a reallocated share of the bandwidth according to a formula
ServiceRate=Num_i/(Denom−SUM(Num_inactive)), Num_i is the respective numerator of the active requester, Denom is the denominator, and SUM(Num_inactive) is the sum of the respective numerators of the inactive requesters in the three or more requesters.

47. The method of claim 45, further comprising allocating the respective service rate to each of the three or more requesters, wherein access to the particular shared resource is to be arbitrated to guarantee the respective service rate of the three or more requesters.

48. The method of claim 45, further comprising:
identifying reactivation of the particular requester, and
returning the reallocated bandwidth originally allocated to the particular requester based on identifying the reactivation.

49. A system comprising:
a shared system resource;
a first device; and
an arbitrator to:
determine that a particular one of three or more requesters of the shared system resource is inactive, wherein each of the three or more requesters is allocated a respective service rate representing a corresponding share of available bandwidth of the system resource and the allocated service rate of the particular requester comprises a first service rate representing a first share of the bandwidth, and at least one of the three or more requesters corresponds to the first device; and
reallocate the first share of the bandwidth to each active requester in the three or more requesters to distribute the first portion of the bandwidth according to the relative services rates of the active requesters, wherein the first share of the bandwidth is to be reallocated while the particular requester remains inactive.

50. The system of claim 49, wherein the shared system resource comprises at least a portion of an interconnect of the system.

51. The system of claim 49, wherein the shared system resource comprises a shared memory resource.
